(19) United States
(12) Patent Application Publication
(10) Pub. No.: US 2008/0199766 A1
(43) Pub. Date: Aug. 21, 2008

(54) Power supply structure with air guide effect

(75) Inventor: Chun-Ju Lin, Taipei County (TW)

Correspondence Address: BACON & THOMAS, PLLC, 625 SLATERS LANE, FOURTH FLOOR, ALEXANDRIA, VA, 22314, US

(73) Assignee: ENERMAX TECHNOLOGY CORPORATION, TAOYUAN CITY (TW)

(21) Appl. No.: 11/707,037

(22) Filed: Feb. 16, 2007

(51) Int. Cl. H01M 10/50

(52) U.S. Cl. 429/120

(57) ABSTRACT

The present invention discloses a power supply structure with an air guide effect, and the structure includes a casing for containing a power supply, and any surface of the casing has at least one opening, and the periphery of the opening includes an inwardly inclined fillet surface, and the surface of the opening that faces the power supply is installed with a bare fan without a frame. The invention not only reduces the overall volume of the power supply and lowers the production cost, but also increases the air intake angle through the guidance of the fillet surface, and allows outside cold air to enter into the casing successfully and increases the airflow entering the casing, so as to enhance the heat dissipating effect.

### BACKGROUND OF THE INVENTION

1. Field of the Invention

The present invention relates to a power supply structure with an air guide effect, and more particularly to a structure that builds an opening on a casing of the power supply, and the periphery of the opening has inwardly inclined fillet surfaces, and the opening is installed with a bare fan without a frame, so that the structure not only increases the air intake angle and the airflow entering into the casing, but also reduces the overall volume of the casing and the production cost.

2. Description of the Related Art

In general, electronic devices install a power supply at the backside of a casing to supply the power required by the operation of the electronic devices. Referring to FIG. 1, the power supply is enclosed by a metal casing, and the casing has an opening facing the positions of the heat generating components of the power supply, and a heat dissipating fan is secured onto the opening. The heat dissipating fan is comprised of a frame, a vane and an electronic component for driving the vane. Since the vane and the electronic component are enclosed in the frame, therefore the overall volume of the heat dissipating fan will be increased accordingly. As a result, the volume of the casing for containing the heat dissipating fan will be increased.

During use, the heat produced by the power supply can be eliminated by using a heat dissipating fan to draw outside cold air into the casing, but such arrangement has the following drawbacks:

1. There is a limited amount of airflow entering into the casing. Since the heat dissipating fan is locked onto the opening of the casing, therefore it is necessary for the opening to reserve a space for the frame of the heat dissipating fan. As a result, the vane cannot be extended fully, and the airflow entering the casing will be affected adversely.

2. The air intake angle is restricted. Since the frame is disposed perpendicularly around the periphery of the vane, and the opening of the casing is also perpendicular to the opening, therefore only the air flowing in the direction perpendicular to the vane can be entered successfully. As a result, the air intake angle is restricted, and the airflow speed is affected adversely.

3. A dead corner of heat dissipation is produced. Since the space between a parallel side of the frame and the casing is limited by the frame, therefore hot air in such space cannot be dissipated effectively, and the heat dissipating effect is affected adversely.

4. The cost is increased. Since it is necessary to add a frame to support and fix the vane, therefore the production cost will be increased.

5. The volume is increased. The volume of the casing is increased greatly, if more heat dissipating fans are installed inside the casing for improving the airflow.

In view of the shortcomings of the prior art, the inventor of the present invention based on years of experience in the related industry to conduct extensive researches and experiments, and finally developed a power supply structure with an air guide effect in accordance with the present invention.

### SUMMARY OF THE INVENTION

Therefore, it is a primary objective of the present invention to provide a power supply structure with an air guide effect, and the structure can effectively increase the airflow and the air intake angle to enhance the heat dissipating effect.

Another objective of the present invention is to provide a power supply structure with an air guide effect, and the structure has a casing for containing a power supply, and a surface of the casing has at least one opening, and the periphery of the opening has an inwardly inclined fillet surface, and the opening is installed with a bare fan without a frame, so that outside cold air can be guided successfully into the casing through the fillet surface to increase the airflow entering into the casing, so as to provide a better heat dissipating effect.

A further objective of the present invention is to provide a power supply structure with an air guide effect, and its fillet surface is an independent circular frame securely fixed into the opening of the casing.

Another objective of the present invention is to provide a power supply structure with an air guide effect, and its fillet surface has one or more air guide grooves with a predetermined interval apart, and the air guide grooves further guide outside air into the casing.

Another further objective of the present invention is to provide a power supply structure with an air guide effect, and its bare fan without a frame has a base precisely locked at the periphery of the base, and the base can be used for installing a vane instead of traditionally installing the vane into the frame, and thus the invention can reduce the volume of the casing significantly.

A further objective of the present invention is to lower the production cost of the product by omitting the frame.

A further objective of the present invention is to eliminate the dead corners incapable of dissipating heat in the space between the vane and the casing by means of the structural design of the invention.

To make it easier for our examiner to understand the technical characteristics of the invention, we use preferred embodiments together with the attached drawings for the detailed description of the invention.

### BRIEF DESCRIPTION OF THE DRAWINGS

FIG. 1 is a schematic view of a prior art;

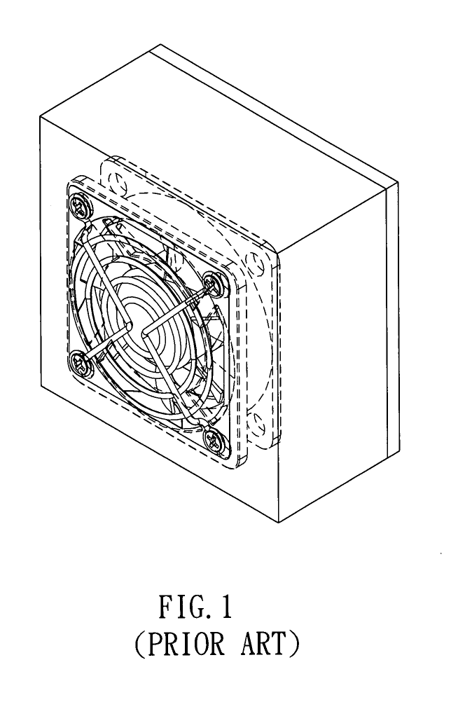

FIG. 2 is a perspective view of a casing of the present invention;

FIG. 3 is an exploded view of a casing and a bare fan installed in the casing in accordance with the present invention;

FIG. 4 is a perspective view of a casing and a bare fan installed in the casing in accordance with the present invention;

FIG. 5 is a cross-sectional view of a casing and a bare fan installed in the casing in accordance with the present invention;

FIG. 6 is a perspective view of another preferred embodiment of the present invetnon; and

FIG. 7 is a perspective view of a further preferred embodiment of the present invetnon.

### DETAILED DESCRIPTION OF THE PREFERRED EMBODIMENTS

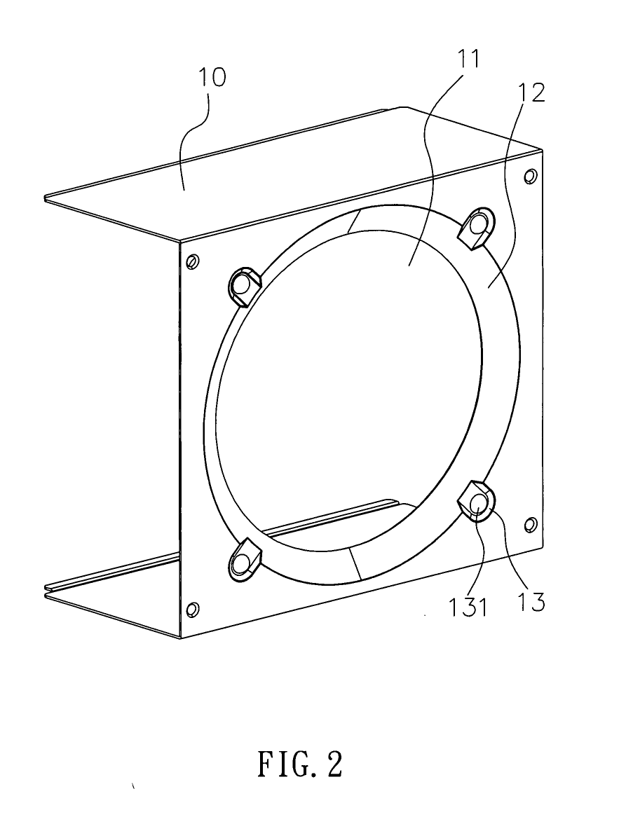

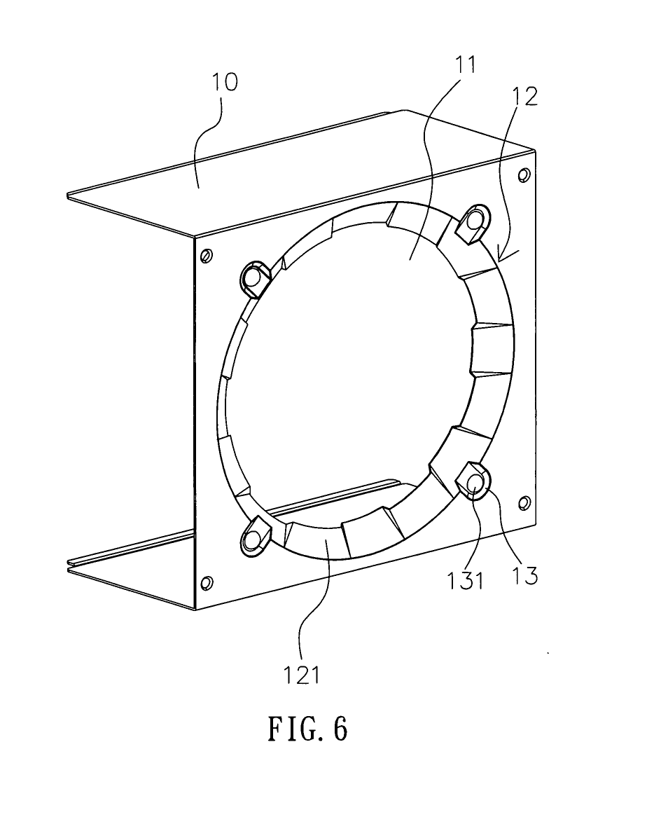

Referring to FIGS. 2 to 5 for a power supply structure with an air guide effect in accordance with the present invention, the structure comprises a casing 10 (only a portion of the casing 10 of this embodiment is shown in the figures) for enclosing a power supply (not shown in the figures), and any surface of the casing 10 has at least one opening 11 (there is one opening 11 in this embodiment, but persons skilled in the art can increase the number of openings 11 as needed), and the periphery of the opening 11 has an inwardly inclined fillet surface 12. Referring to FIG. 6, the fillet surface 12 has one or more air guide grooves 121 disposed at a predetermined interval apart, and the air guide grooves 121 is sunken deeper than the fillet surface.

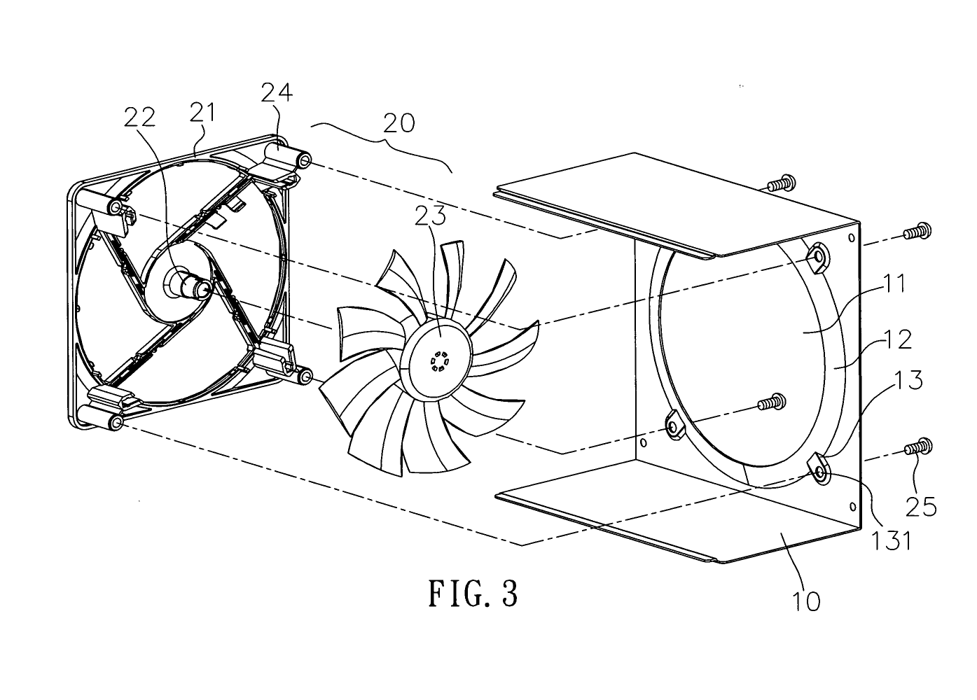

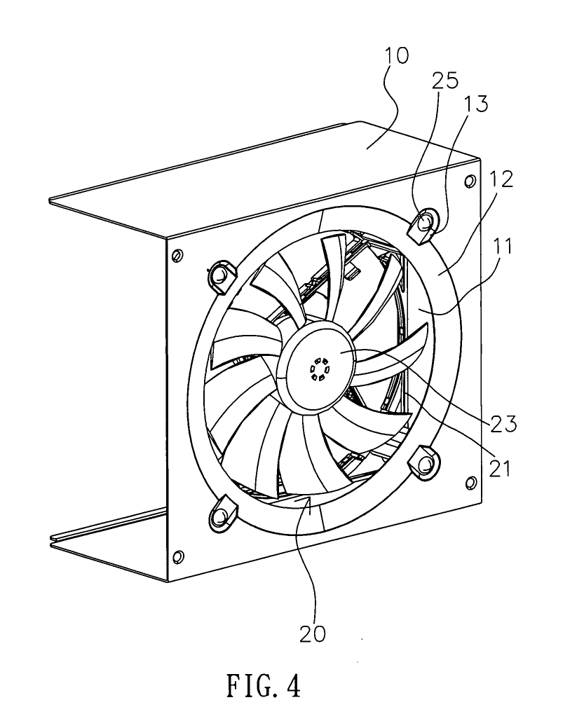

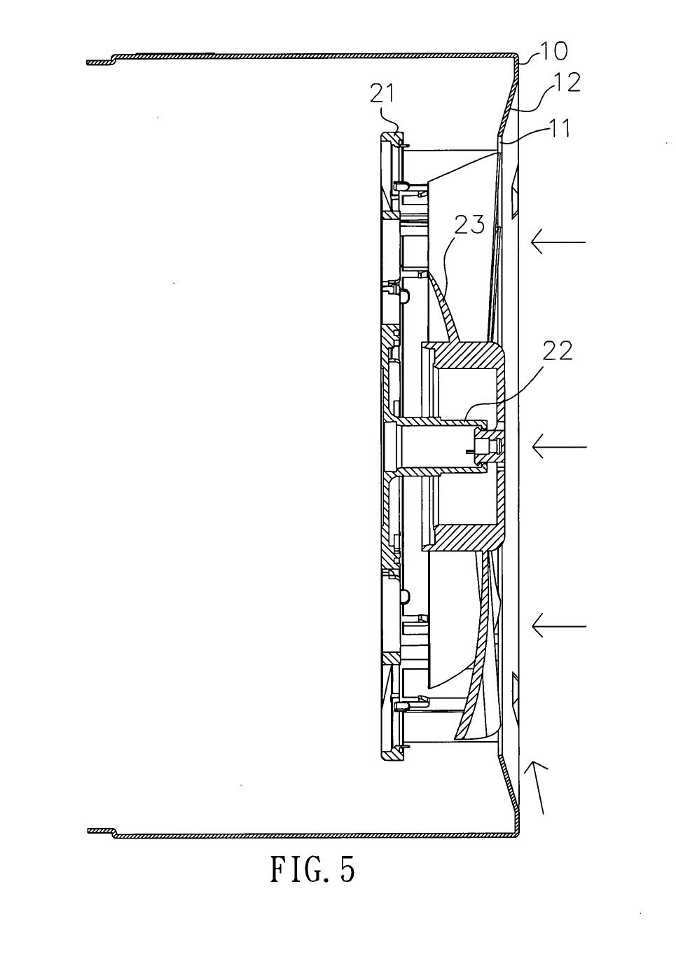

Further, the periphery of the fillet surface 12 has one or more protruding ears 13, and the protruding ears 13 separately have a locking hole 131 (as shown in FIG. 2), and a bare fan 20 without a frame is installed onto the opening 11 and facing a surface of the power supply, and the bare fan 20 has a base 21, and the base 21 installs a circuit board (not shown in the figures), and the center of the base 21 has an axle sleeve 22 for sheathing a vane 23, and each distal edge of the base 21 has a protruding screw pillar 24, such that the screw 25 can be passed through the locking hole 131 and locked into the screw pillar 24 to fix the base 21 onto the opening 11. The vane 23 faces the opening 11 (as shown in FIGS. 3 and 4) and thus outside cold air can be guided into the casing 10 with a larger guiding angle by means of the fillet surface 12 (as shown in FIG. 5) to increase the airflow entering into the casing 10 and provide a better heat dissipating effect. Since the bare fan 20 is installed onto the opening through the vane 23 instead of traditionally installing the vane into the frame and then installing the frame into the casing 10, therefore the invention can greatly reduce the volume of the casing 10 and eliminate the dead corners of the space between the casing 10 and the vane 23, and lower the production cost.

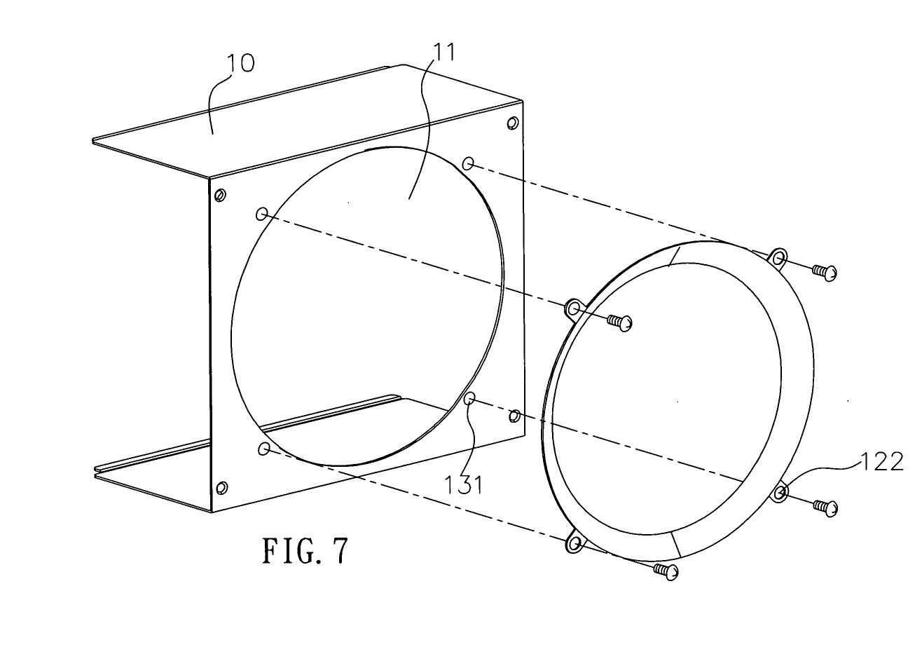

Referring to FIG. 7, the fillet surface 12 is an independent circular frame, and the periphery of the fillet surface 12 has a protruding ear portion 122, and the ear portion 122 can be secured into a locking hole 131 of the casing 10 by a screw to fix the fillet surface 12 into the opening 11.

In summation of the disclosures of the foregoing preferred embodiments, the design in accordance with the present invention overcomes the shortcomings and enhances the performance over the conventional structure by improving the intake airflow and heat dissipating efficiency of a power supply. The invention further complies with the patent application requirements and is duly filed for a patent application.

While the invention has been described by means of specific embodiments, numerous modifications and variations could be made thereto by those skilled in the art without departing from the scope and spirit of the invention set forth in the claims.

What is claimed is:

1. A power supply structure with an air guide effect, comprising:
a casing; for containing a power supply;
at least one opening, disposed on a surface of said casing; and
a fillet surface, inclined inward and disposed around the periphery of said opening;
thereby, outside cold air can be guided into said casing through said fillet surface for enhancing the airflow entering said casing.

2. The power supply structure with an air guide effect of claim 1, wherein said opening is installed with a bare fan that faces said power supply, such that the volume of said casing can be reduced.

3. The power supply structure with an air guide effect of claim 2, wherein said fan with its vanes is installed on a base, and said base has a screw pillar disposed separately on both distal ends of said base and locked to a distal edge of said fillet surface by a screw.

4. The power supply structure with an air guide effect of claim 1, wherein said opening comes with a quantity of at least one.

5. The power supply structure with an air guide effect of claim 1, wherein said fillet surface is an independent circular frame securely fixed into said casing opening.

6. The power supply structure with an air guide effect of claim 1, wherein said fillet surface has one or more air guide grooves disposed thereon with a predetermined interval apart from each other and said air guide grooves further guide outside air into said casing.
